(19) United States
(12) Patent Application Publication
(10) Pub. No.: US 2008/0239638 A1
(43) Pub. Date: Oct. 2, 2008

(54) DISPLAY DEVICE STAND

(75) Inventors: Motonari Chinuki, Chiba (JP); Yoshihiko Kato, Chiba (JP); Kazunori Sukeda, Tokyo (JP)

Correspondence Address: HARNESS, DICKEY & PIERCE, P.L.C., P.O. BOX 828, BLOOMFIELD HILLS, MI, 48303, US

(73) Assignee: THE BANK OF TOKYO-MITSUBISHI UFJ, LTD., Tokyo (JP)

(21) Appl. No.: 11/938,466

(22) Filed: Nov. 12, 2007

(30) Foreign Application Priority Data
Mar. 26, 2007 (JP) 2007-79515

(51) Int. Cl. G06F 1/16

(52) U.S. Cl. 361/681

(57) ABSTRACT

There is provided a display device stand that allows a TV conference to be held in a limited space, such as a small room, in a satisfactory manner. A display device stand 1 for supporting a display device 30 includes a base 2, a column 12 standing on the base 2, and angular adjustment member 20 provided at the top of the column 12. The rear side of the display device 30 is connected to the angular adjustment member 20 and the display device 30 can be angularly adjusted between the position where the display screen of the display device 30 is oriented upward and the position where the display screen of the display device 30 is oriented horizontally. The angular adjustment member 20 is a hinge 20 having two blades that can swing with respect to each other. By disposing one or more hinges 20 at the top of the column 12, fixing one of the blades of the hinge 20 to the top of the column 12, and fixing the other blade to the rear side of the display device 30, the display device 30 can swing integrally with the other blade. The hinge 20 has a torque greater than a maximum rotational torque acting on the display device 30, so that the display device 30 can be reliably held at an arbitrary angle.

### BACKGROUND OF THE INVENTION

1. Field of the Invention

The present invention relates to a display device stand, and particularly to a display device stand that is effective in angularly adjusting and supporting a panel display device, such as a liquid crystal monitor.

2. Description of the Related Art

In recent years, there have been provided various TV conference systems using networks, and they have been widely used, for example, when panel display devices, such as liquid crystal monitors, are used to hold a TV conference between attendees at locations remote from each other.

For example, Japanese Patent Laid-Open No. 2006-30913 discloses, as an exemplary panel display device that can be used in such TV conference systems, a display device stand including a base, a column standing on the upper side of the base, and casters attached at a plurality of locations on the underside of the base. Japanese Patent Laid-Open No. 2006-30913 also discloses an example in which a display device is attached to the upper end of the column of the display device stand.

A TV conference between attendees at locations remote from each other using display devices, each having such a configuration, can be held by preparing such display devices, the number of which corresponds to the number of attendees participating in the TV conference, placing the display devices in such a way that they face the attendees, and showing the attendees the contents displayed on the display screens of the individual display devices. In this way, the TV conference will proceed.

### SUMMARY OF THE INVENTION

Since display devices, each having the configuration described above, should be prepared and placed, the number of which corresponds to the number of attendees participating in the TV conference, a large space is required when a large number of attendees participate. A limited space, such as a small room, may therefore pose a difficulty in holding a TV conference.

The present invention has been made in view of the conventional problem described above and aims to provide a display device stand that allows a TV conference to be held with display devices, the number of which is fewer than that of attendees, so that the space necessary for the TV conference is substantially reduced and the TV conference can be held in a limited space, such as a small room, in a satisfactory manner.

To solve the above problems, according to the present invention, a display device stand for supporting a display device includes a base, a column standing on the base, and an angular adjustment member provided at the top of the column. The rear side of the display device is connected to the angular adjustment member, and the angular adjustment member is configured so that the display device can be angularly adjusted at least between the position where the display screen of the display device is oriented upward and the position where the display screen of the display device is oriented horizontally.

With the display device stand according to the present invention, since the angular adjustment member can angularly adjusts the display device at least between the position where the display screen of the display device is oriented upward and the position where the display screen of the display device is oriented horizontally, the display device can be angularly adjusted at a position where the display screen is visible from both sides.

Therefore, when a TV conference is held with a large number of attendees, two attendees can share one display device, so that the number of display devices to be prepared may be half the number of the attendees. The space necessary for the TV conference can thus be significantly reduced, and the TV conference can be held in a space of a small room in a satisfactory manner.

In the invention, the display device may be configured in such a way that it can be angularly adjusted to a position where the display screen of the display device is oriented downward below the horizontal direction.

In the display device stand according to the present invention, by angularly adjusting the display device at a position where the display screen of the display device is oriented downward below the horizontal direction when the display device is not used, it is possible to prevent dust and the like from attaching to the surface of the display device.

In the invention, the angular adjustment member may be configured in such a way that it is a hinge having two blades that can swing with respect to each other, and by disposing one or more hinges at the top of the column, fixing one of the blades of the hinge to the top of the column, and fixing the other blade to the rear side of the display device, the display device can swing integrally with the other blade.

In the display device stand according to the present invention, the other blade of the hinge swings relative to the one of the blades, so that the display device swings integrally with the other blade and the display device is adjusted to the angle corresponding to the swing position of the other blade.

In the invention, the column may be configured in such a way that it has a height adjustment mechanism that extends or retracts the column in the vertical direction, and by using the height adjustment mechanism to extend or retract the column in the vertical direction, the vertical position of the display device can be adjusted.

In the display device stand according to the present invention, by using the height adjustment mechanism to extend or retract the column in the vertical direction, the display device moves integrally with the column in the vertical direction, so that the vertical position of the display device is adjusted.

In the invention, an attachment portion may be provided at the top of the column. One of the blades of the hinge may be fixed to the attachment portion, and the attachment portion may have a handle that activates the height adjustment mechanism of the column to extend or retract the column in the vertical direction.

In the display device stand according to the present invention, by operating the handle of the attachment portion to activate the height adjustment mechanism so as to extend or retract the column, the display device moves integrally with the column in the vertical direction, so that the vertical position of the display device is adjusted.

In the invention, when the display device is angularly adjusted in such a way that the display screen is oriented horizontally, the hinge may have a torque greater than the rotational torque acting on the display device.

In the display device stand according to the present invention, since the hinge has a torque greater than a maximum rotational torque acting on the display device, when the display device is adjusted to an arbitrary angular position, the display device can be reliably held at that position.

As described above, with the display device stand according to the present invention, since the display device can be angularly adjusted in an arbitrarily manner between the position where the display screen of the display device is oriented upward and the position where the display screen of the display device is oriented horizontally, the display device can be adjusted at an angle where the display screen is visible from both sides.

Therefore, when a TV conference is held with a large number of attendees, two attendees can share one display device, so that the number of display devices to be prepared may be half the number of the attendees. The space necessary for the TV conference can thus be significantly reduced and the TV conference can be held with a large number of attendees in a limited space, such as a small room.

### BRIEF DESCRIPTION OF THE DRAWINGS

FIG. 1 is a front view showing the entirety of an embodiment of the display device stand according to the present invention;

FIG. 2 is a side view of FIG. 1;

FIG. 3 is a plan view of FIG. 1;

FIG. 4 is a front view showing the display device stand with a column extended;

FIG. 5 is a side view of FIG. 4;

FIG. 6 is a side view showing the display device stand with its display device inclined at approximately 45 degrees;

FIG. 7 is an enlarged view of the rear side of the display device;

FIG. 8 is a plan view of FIG. 7;

FIG. 9 is an enlarged view showing the display device with its display screen angularly adjusted and oriented horizontally;

FIG. 10 is an enlarged view showing the display device with its display screen angularly adjusted and inclined at approximately 45 degrees;

FIG. 11 is an enlarged view showing the display device with its display screen angularly adjusted and oriented upward;

FIG. 12A is a plan view of a hinge;

FIG. 12B is a side view of FIG. 12A;

FIG. 12C is a front view of FIG. 12A; and

FIG. 13 is a layout diagram of display devices when a TV conference is held.

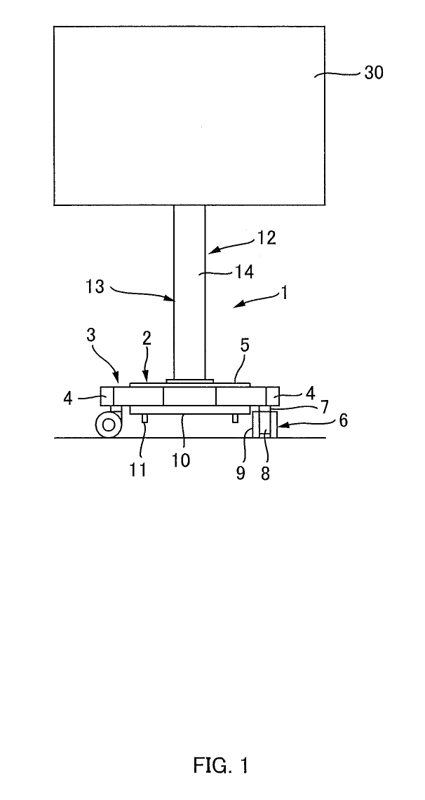

### DETAILED DESCRIPTION OF THE PREFERRED EMBODIMENT

An embodiment of the present invention will be described below with reference to the drawings.

The display device stand 1 in the present embodiment can be applied to various TV conference systems using networks, and, for example, effective in angularly adjusting and supporting a panel-type display device, such as a liquid crystal monitor, when such a display device is used to hold a TV conference between locations remote from each other with a large number of attendees on both sides. The display device stand 1 includes a base 2 pivotable and movable in four directions, forward and rearward as well as rightward and leftward, on the floor of a room or the like, a column 12 provided on the upper side of the base 2 and standing perpendicular thereto, an attachment portion 16 provided integrally with the top of the column 12, and angular adjustment member 20 attached to the attachment portion 16. A display device 30 is attached to the angular adjustment member 20.

The base 2 includes a leg 3, a base plate 5 provided integrally with the upper side of the leg 3, casters 6 attached to the underside of the leg 3, and a weight 10 removably attached to the underside of the base plate 5. The column 12 perpendicularly stands on the upper side of the base plate 5.

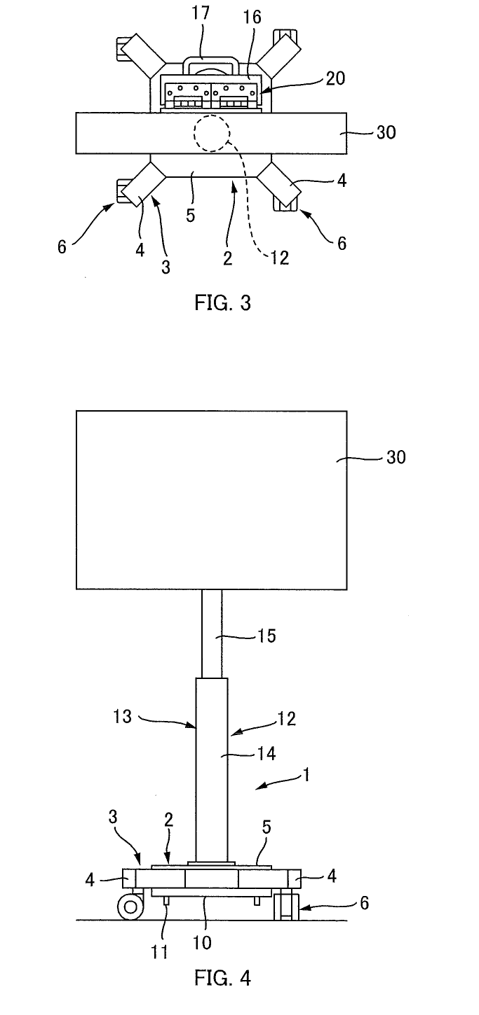

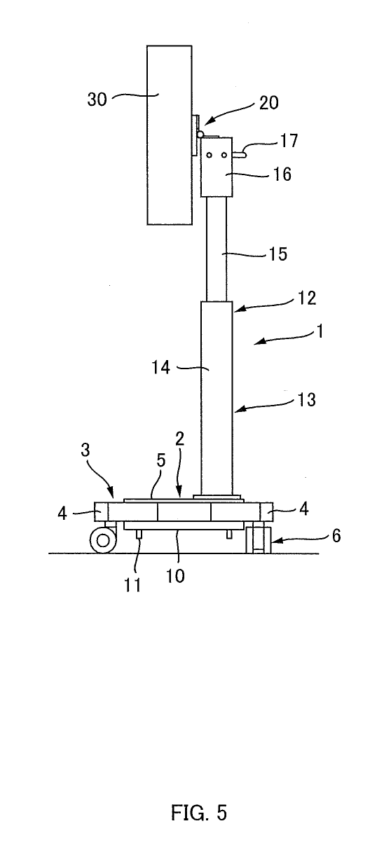

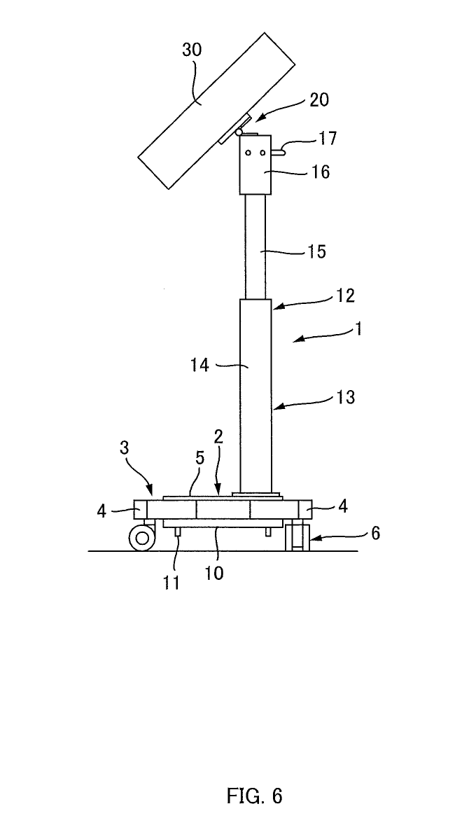

The leg 3 is formed by combining four supporting legs 4 crosswise, as shown in FIG. 3. The rectangular plate-like base plate 5 is integrally connected to the upper center of the combined supporting legs 4 using welding or the like, and the column 12 perpendicularly stands on the base plate 5 in such a way that the column 12 is located behind the display screen of the display device 30.

Each of the casters 6 is attached to the underside of the end of each supporting leg 4 of the leg 3, and these casters 6 support the base 2, the column 12 standing on the base 2, and the display device 30 attached to the top of the column 12 via the angular adjustment member 20 and allow them integrally to pivot and move in four directions, forward and rearward as well as rightward and leftward, on the floor.

The caster 6 is a commercially available caster and includes a base section 7 secured to the underside of each supporting leg 4 with screws (not shown), a support section 8 pivotably provided under the base section 7, a shaft (not shown), the central part of which is supported by the support section 8, and a wheel 9 rotatably supported by the shaft via bearings (not shown). When each of the wheels 9 rotates around the shaft and pivots by following the pivotal movement of the support section 8, the base 2, the column 12 and the display device 30 will integrally move in four directions, forward and rearward as well as rightward and leftward, on the floor and pivot on the floor.

The caster 6 is not limited to the one configured as described above, but may be various other commercially available types. The supporting legs 4 of the leg 3 are not also limited to the cross shape but may be formed in other shapes.

The weight 10 is, for example, made of metallic material, such as lead, and shaped into a plate. The weight 10 is removably attached to the center of the underside of the base plate 5 with screws 11. By adding the mass of the weight 10 to the underside of the base plate 5, it is possible to increase the mass of the base 2 and shift the position of the center of gravity of the display device stand 1 including the display device 30 downward. The stability of the base 2 is therefore enhanced, so that the display device 30 supported above the base 2 via the column 12 can be supported in a stable manner and the length of each supporting leg 4 can be reduced.

In this case, the space formed under the underside of the base plate 5 is used to attach the weight 10. Therefore, by changing the number of weights 10 according to the mass, the position of the center of gravity and the like of the display device 30 being used, the base 2 can support various display devices 30 different in masses, position of center of gravity and the like from each other in a stable manner.

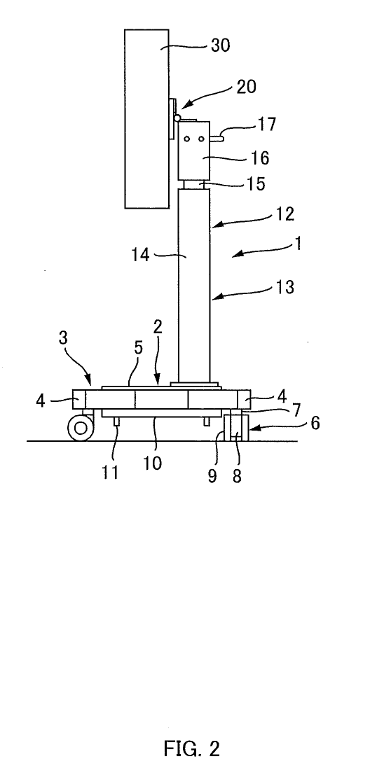

The column 12 perpendicularly stands at a position displaced from the center of the base plate 5 to the rear side of the display screen of the display device 30 (rightward in FIG. 2). The attachment portion 16 is provided integrally with the top of the column 12, and the display device 30 is attached to the attachment portion 16 via the angular adjustment member 20.

The column 12 has an extendable vertical height adjustment mechanism 13. By using the height adjustment mechanism 13 to extend or retract the column 12 in the vertical direction, it is possible to adjust the vertical position of the display device 30 attached to the attachment portion 16 at the top of the column 12 via the angular adjustment member 20.

In the present embodiment, the column 12 with the height adjustment mechanism 13 is a commercially available air suspension including a cylinder body 14 and a reciprocately movable rod 15 in the cylinder body 14. In this case, the lower end of the cylinder body 14 of the air suspension is secured to the upper side of the base plate 5 of the base 2 with screws, and the display device 30 is attached via the angular adjustment member 20 to the upper side of the box-like attachment portion 16 provided integrally with the upper end of the rod 15.

The attachment portion 16 is not limited to the box shape, but may be formed in other shapes such as a plate.

A U-shaped handle 17 is provided integrally with the rear side (the right side in FIG. 2) of the attachment portion 16 in such a way that the handle 17 juts out from the rear. By holding the handle 17 by hand and vertically moving the rod 15, the display device 30 can be brought to the position corresponding to the vertical position of the rod 15.

A locking mechanism (not shown) that secures the rod 15 at a predetermined vertical position is provided between the cylinder body 14 and the rod 15. By using the locking mechanism to secure the rod 15, it is possible to secure the display device 30 attached to the rod 15 via the attachment portion 16 at an arbitrary vertical position.

The column 12 is not limited to the air suspension, but may be other mechanisms as long as they have an extendable vertical height adjustment mechanism 13.

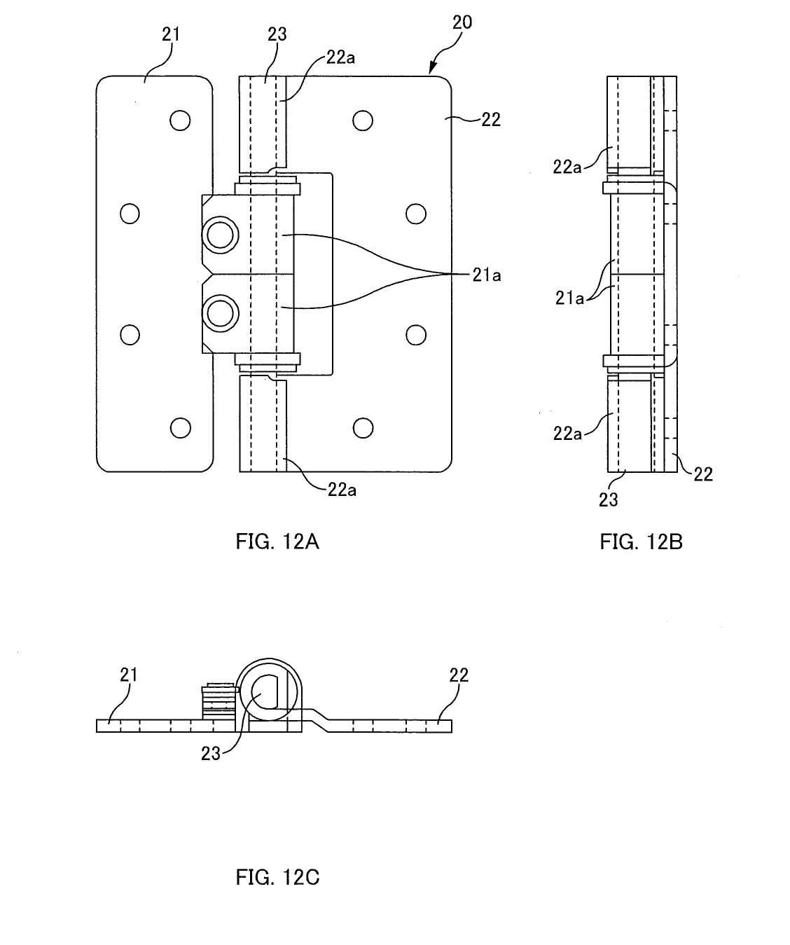

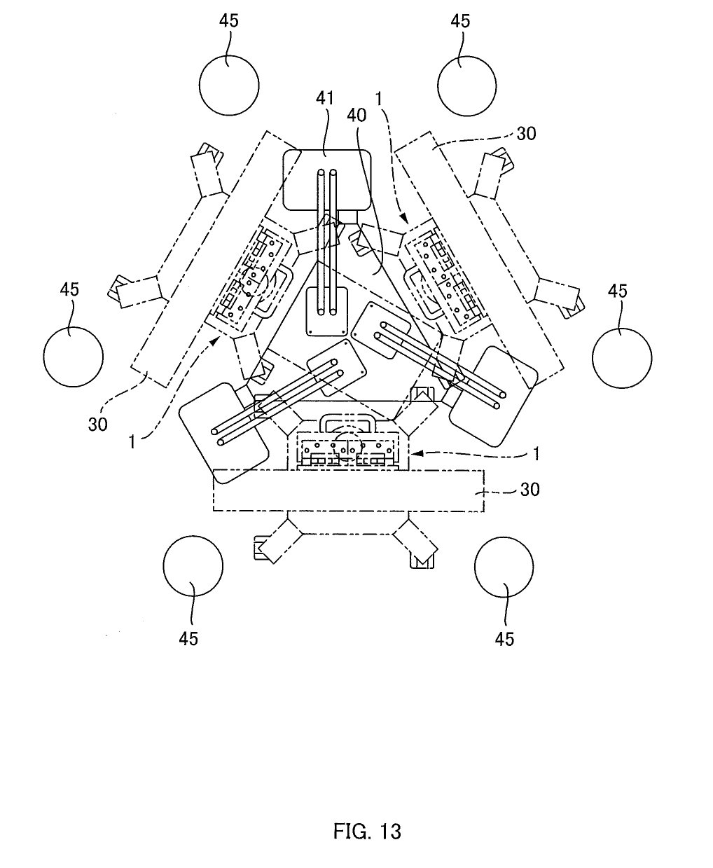

The angular adjustment member 20 is a hinge 20 including two rectangular plate-like blades 21 and 22, sleeves 21a and 22a provided integrally with the edges of the longer sides of the blades 21 and 22, respectively, and a connecting rod 23 that connects the sleeves 21a of the blade 21 with the sleeves 22a of the blade 22 in such a way that the sleeves 21a and 22a can rotate with respect to each other, as shown in FIG. 12. In such a configuration, the two blades 21 and 22 can swing with respect to each other within a predetermined angular range around the connecting rod 23.

The hinge 20 is adjusted in such a way that the rotational torque necessary to swing the blades 21 and 22 is greater than a maximum torque generated by the display device 30, as will be described later.

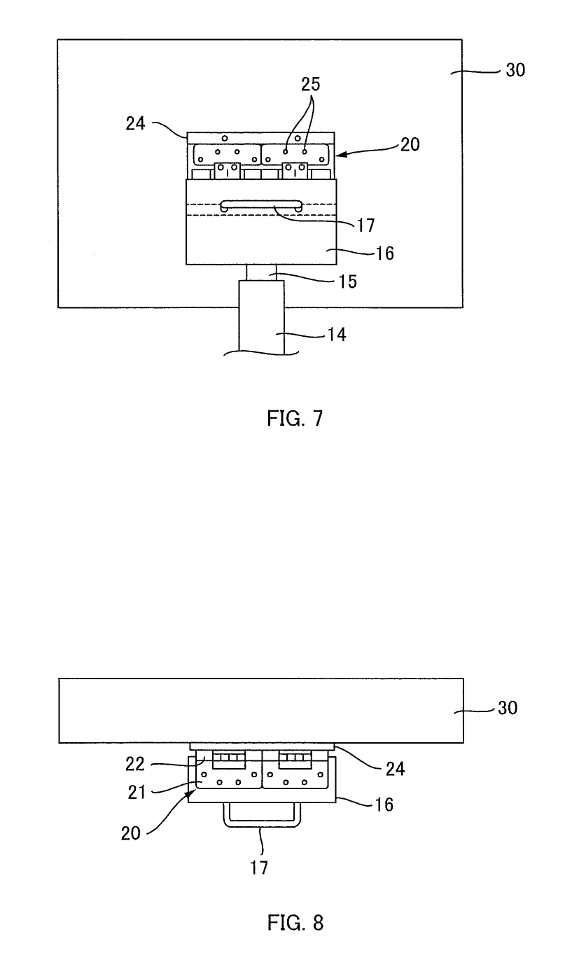

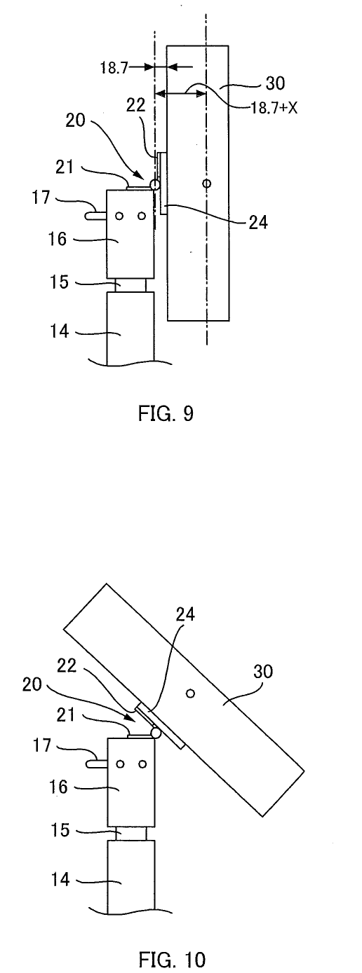

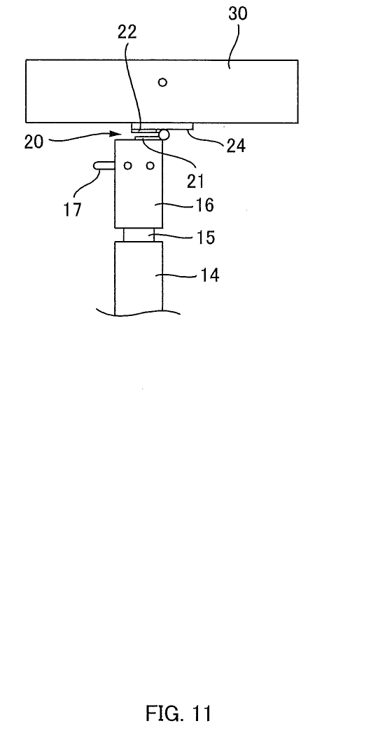

In the present embodiment, as shown in FIGS. 7 and 8, two hinges 20 are disposed in series on the upper side of the attachment portion 16. For each of the hinges 20, one of the blades of the hinge 20, the blade 21, is fixed to the upper side of the attachment portion 16 with screws 25, while the other blade 22 is fixed to the center of the rear side of the display device 30 via a plate 24 with the screws 25. The display device 30 thus swings integrally with the other blades 22 of the hinges 20 on the upper side of the attachment portion 16. In this way, the display device 30 can swing between the position where the display screen is oriented upward (the position where the other blades 22 are at their closed positions) and the position where the display screen is oriented horizontally (the position where the other blades 22 are angled substantially at 90 degrees with respect to the blades 21), and the display device 30 can be adjusted at an arbitrary angle between these two positions.

The hinge 20 is configured in such a way that when the display device 30 is angularly adjusted to an arbitrary position, the hinge 20 has a torque greater than the rotational torque acting on the hinge 20 generated by the mass of the display device 30 at the adjusted position. In this way, the hinge 20 reliably holds the display device 30 at an arbitrary position. That is, since a maximum rotational torque acts on the hinge 20 at the position where the display screen of the display device 30 is oriented horizontally, the hinge 20 is selected to have a torque greater than the rotational torque acting on the display device 30 at that position. Use of the hinge 20 having such a torque allows the display device 30 to be reliably held at an arbitrary position.

Alternatively, the display device 30 may be angularly adjusted to a position where the display screen of the display device 30 is oriented downward below the horizontal direction. By angularly adjusting the display device 30 at such a position, it is possible to prevent dust and the like from attaching to the display screen of the display device 30 when not used.

In the present embodiment, the display device 30 is a 24-inch liquid crystal monitor having a weight of 9 kg. The rotational torque acting on the display device 30 measured at the position where the display screen of the display device 30 is oriented horizontally was a maximum torque and approximately 6.95 Nm. The hinge 20 having a torque greater than this rotational torque (approximately 9.2 Nm) was therefore selected and used.

In the present embodiment, although two hinges 20, each having a torque of approximately 4.6 Nm, disposed in series are used, one hinge 20 or more than two hinges 20 may be used to ensure a torque of 9.2 Nm. The hinge 20 having a torque of approximately 9.2 Nm is used because an error of the torque of the hinge 20 is taken into account.

How to calculate the torque acting on the hinge 20 will be specifically described below.

### <Prerequisites of the Calculation>

1) Mass of the display device (liquid crystal monitor); W (kg)
2) Thickness of the display device (liquid crystal monitor); D (mm)
3) Rotational torque acting on the hinge; F (Nm)
4) Thickness D of the display device (liquid crystal monitor) having a size of 19 inch or greater; proportional to the mass of the display device and satisfying the following equation: D=10W (mm)
5) Position of the center of gravity of the display device (liquid crystal monitor); the center of both the height and width of the display device and apart from the front side by one-third of the thickness of the display device
6) Distance from the center of the connecting rod of the hinge to the display device (liquid crystal monitor); 18.7 (mm)
Under the above prerequisites, the rotational torque F acting on the hinge is calculated by the following equation:

F=W×9.81×(10W×2/3+18.7)/1000

The rotational torque H (Nm) of the hinge to be selected satisfies the following equation:

F<H<1.4F

When the mass of the display device (liquid crystal monitor) is 9 kg,

F=9×9.81×(10×9×2/3+18.7))/1000=6.95 (Nm)

6.95<H<9.73

Therefore, two hinges, each having a torque of 4.6 (Nm), may be used.

When the equation 4) is not applicable, the torque is calculated as follows:

F=9×9.81×(85×2/3+18.7))/1000=6.65 (Nm) (The value 85 is the actual thickness of the monitor.)

6.65<H<9.31

In this case, again, two hinges, each having a torque of 4.6 (Nm), may be used.

To hold a TV conference by using the display devices 30, each attached to the display device stand 1 having the above configuration according to the present embodiment, as shown in FIG. 13, for example, when the number of attendees 45 of the TV conference is six, the six attendees 45 are seated in a circle, and each of the display device 30 is placed between adjacent attendees 45. Then, by swinging each of the display devices 30 at the top of the column 12 to adjust the inclination angle of the display device 30, the display screen of the display device 30 is positioned to be visible from both sides of the display screen.

After the inclination angle of each of the display devices 30 is set, the attendees 45 on both sides look at the display screen of the display device 30. In this way, the TV conference can proceed while the attendees look at the contents displayed on the display screens.

In the example shown in FIG. 13, a housing rack 40, having a triangular shape when viewed from above, which houses a personal computer body, and housing sections 41 for keyboards and mouses are placed among three display devices 30. The reduced length of the supporting legs 4 allows this compact layout.

In the display device stand 1 having the configuration described above according to the present embodiment, since the display device 30 can swing between the position where the display screen is oriented upward and the position where the display screen is oriented horizontally as well as be adjusted at an arbitrary angle between these positions, the display device 30 can be adjusted at an angle where the display screen is visible from both sides.

Therefore, when a TV conference is held, the number of display devices 30 to be prepared can be half the number of the attendees. The space necessary for the TV conference can thus be significantly reduced and the TV conference can be held in a limited space, such as a small room, in a satisfactory manner.

Since the hinge 20 that angularly adjusts and supports the display device 30 is selected to have a torque greater than a maximum rotational torque acting on the display device 30, when the display device 30 is angularly adjusted at any angle within a swingable range, the display device 30 can be reliably held at that position.

In the above description, although the hinge 20 is used as the angular adjustment member 20 for adjusting the angle of the display device 30, the angular adjustment member is not limited to the hinge 20, but may be other member 20 as long as they have a function capable of adjusting the display device 30 at a predetermined angle and holding the display device 30 at that position.

Furthermore, in the above description, although the column 12 with the height adjustment mechanism 13 is used, a column with no height adjustment mechanism may be used.

What is claimed is:

1. A display device stand for supporting a display device, comprising:
a base;
a column standing on the base; and
an angular adjustment member provided at the top of the column to be connected to the rear side of the display device so that the display device can be angularly adjusted at least between the position where the display screen of the display device is oriented upward and the position where the display screen of the display device is oriented horizontally.

2. The display device stand according to claim 1, wherein the angular adjustment member is configured so that the display device can be angularly adjusted to a position where the display screen of the display device is oriented downward below the horizontal direction.

3. The display device stand according to claim 1, wherein the angular adjustment member is a hinge having two blades that can swing with respect to each other, and by disposing one or more hinges at the top of the column, fixing one of the blades of the hinge to the top of the column, and fixing the other blade to the rear side of the display device, the display device can swing integrally with the other blade.

4. The display device stand according to claim 2, wherein the angular adjustment member is a hinge having two blades that can swing with respect to each other, and by disposing one or more hinges at the top of the column, fixing one of the blades of the hinge to the top of the column, and fixing the other blade to the rear side of the display device, the display device can swing integrally with the other blade.

5. The display device stand according to claim 1, wherein the column has a height adjustment mechanism that extends or retracts the column in the vertical direction, and by using the height adjustment mechanism to extend or retract the column in the vertical direction, the vertical position of the display device can be adjusted.

6. The display device stand according to claim 2, wherein the column has a height adjustment mechanism that extends or retracts the column in the vertical direction, and by using the height adjustment mechanism to extend or retract the column in the vertical direction, the vertical position of the display device can be adjusted.

7. The display device stand according to claim 3, wherein the column has a height adjustment mechanism that extends or retracts the column in the vertical direction, and by using the height adjustment mechanism to extend or retract the column in the vertical direction, the vertical position of the display device can be adjusted.

8. The display device stand according to claim 4, wherein the column has a height adjustment mechanism that extends or retracts the column in the vertical direction, and by using the height adjustment mechanism to extend or retract the column in the vertical direction, the vertical position of the display device can be adjusted.

9. The display device stand according to claim 5 further comprising an attachment portion provided at the top of the column, wherein one of the blades of the hinge is fixed to the attachment portion, and the attachment portion has a handle that activates the height adjustment mechanism of the column to extend or retract the column in the vertical direction.

10. The display device stand according to claim 6 further comprising an attachment portion provided at the top of the column, wherein one of the blades of the hinge is fixed to the attachment portion, and the attachment portion has a handle that activates the height adjustment mechanism of the column to extend or retract the column in the vertical direction.

11. The display device stand according to claim 7 further comprising an attachment portion provided at the top of the column, wherein one of the blades of the hinge is fixed to the attachment portion, and the attachment portion has a handle that activates the height adjustment mechanism of the column to extend or retract the column in the vertical direction.

12. The display device stand according to claim 8 further comprising an attachment portion provided at the top of the column, wherein one of the blades of the hinge is fixed to the attachment portion, and the attachment portion has a handle that activates the height adjustment mechanism of the column to extend or retract the column in the vertical direction.

13. The display device stand according to claim 1, wherein when the display device is angularly adjusted in such a way that the display screen is oriented horizontally, the hinge has a torque greater than the rotational torque acting on the display device.

14. The display device stand according to claim 2, wherein when the display device is angularly adjusted in such a way that the display screen is oriented horizontally, the hinge has a torque greater than the rotational torque acting on the display device.

15. The display device stand according to claim 3, wherein when the display device is angularly adjusted in such a way that the display screen is oriented horizontally, the hinge has a torque greater than the rotational torque acting on the display device.

16. The display device stand according to claim 4, wherein when the display device is angularly adjusted in such a way that the display screen is oriented horizontally, the hinge has a torque greater than the rotational torque acting on the display device.

17. The display device stand according to claim 5, wherein when the display device is angularly adjusted in such a way that the display screen is oriented horizontally, the hinge has a torque greater than the rotational torque acting on the display device.

18. The display device stand according to claim 6, wherein when the display device is angularly adjusted in such a way that the display screen is oriented horizontally, the hinge has a torque greater than the rotational torque acting on the display device.

19. The display device stand according to claim 7, wherein when the display device is angularly adjusted in such a way that the display screen is oriented horizontally, the hinge has a torque greater than the rotational torque acting on the display device.

20. The display device stand according to claim 8, wherein when the display device is angularly adjusted in such a way that the display screen is oriented horizontally, the hinge has a torque greater than the rotational torque acting on the display device.

21. The display device stand according to claim 9, wherein when the display device is angularly adjusted in such a way that the display screen is oriented horizontally, the hinge has a torque greater than the rotational torque acting on the display device.

22. The display device stand according to claim 10, wherein when the display device is angularly adjusted in such a way that the display screen is oriented horizontally, the hinge has a torque greater than the rotational torque acting on the display device.

23. The display device stand according to claim 11, wherein when the display device is angularly adjusted in such a way that the display screen is oriented horizontally, the hinge has a torque greater than the rotational torque acting on the display device.

24. The display device stand according to claim 12, wherein when the display device is angularly adjusted in such a way that the display screen is oriented horizontally, the hinge has a torque greater than the rotational torque acting on the display device.
